(19) United States
(12) Patent Application Publication
(10) Pub. No.: US 2008/0201559 A1
(43) Pub. Date: Aug. 21, 2008

(54) Switching Device and Corresponding Method for Activating a Load

(75) Inventor: Bernhard Forstl, Ihrlerstein (DE)

Correspondence Address: LERNER GREENBERG STEMER LLP, P O BOX 2480, HOLLYWOOD, FL, 33022-2480, US

(73) Assignee: VDO AUTOMOTIVE AG, Regensburg (DE)

(21) Appl. No.: 12/033,054

(22) Filed: Feb. 19, 2008

(30) Foreign Application Priority Data
Feb. 19, 2007 (DE) 10 2007 008 168.7

(51) Int. Cl. G06F 9/48

(52) U.S. Cl. 712/225; 712/E09.023

(57) ABSTRACT

A cost-effective safety concept for safety-relevant applications in motor vehicles accordingly activates a load not directly from a central unit, but instead indirectly via a switching device. The latter has a first and a second register for the acquisition of the same control data from the central unit, and a third register for outputting data to the load. A transmission device transmits data from the second register to the third register. A first comparison logic compares a content of the second register with that of the third register and sends an interrupt to the central unit, when the two contents are not identical. A second comparison logic compares the content of the first and second registers and enables the transmission device, when the contents of the two registers are identical and otherwise blocks the transmission device. The last held state is thus maintained in the event of an error.

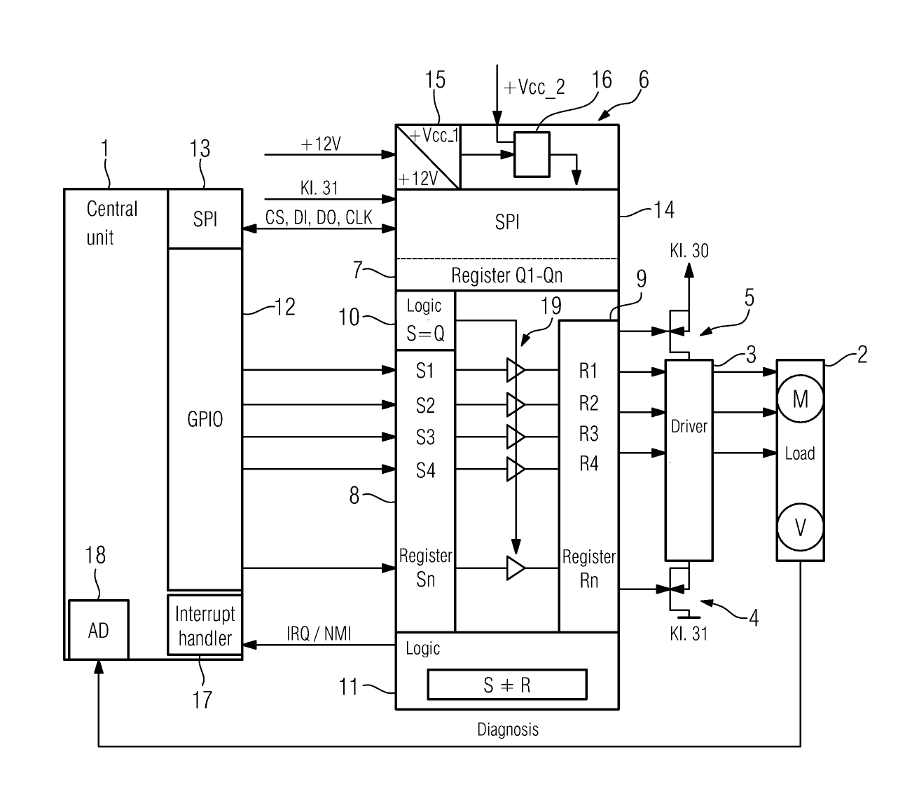

### CROSS-REFERENCE TO RELATED APPLICATION

This application claims the priority, under 35 U.S.C. § 119, of German application DE 10 2007 008 168.7, filed Feb. 19, 2007; the prior application is herewith incorporated by reference in its entirety.

### BACKGROUND OF THE INVENTION

### Field of the Invention

The present invention relates to a switching device for activating a load in particular in the field of automotive engineering. In addition, the present invention relates to a control system with a control unit and the switching device as well as a corresponding method for activating a load.

It is necessary, above all for safety-relevant applications, for the system to achieve a safe state in the event of an error. As a rule, the state that was active and valid prior to the occurrence of the error is the safe state. This term “safe state” can be explained using the example of an electronic steering wheel lock as follows: if an electronic steering wheel lock was unlocked at the point in time t1, i.e. the steering is released and pins are not blocking the steering, then in the event of an error, under no circumstances should the steering wheel lock be activated. Conversely, if the steering wheel lock was activated at the point in time t2, then it must remain locked in the event of an error.

It is thus necessary on the one hand to be able to obtain a reliable statement as to the state of the system and on the other hand for the system to achieve a safe state of this type. Up to now, redundancy measures have been used to achieve a valid statement as to the state of the system. Two parallel branches that are independent of each other are used as a rule to set up the redundancy, each branch having a microcontroller.

### BRIEF SUMMARY OF THE INVENTION

It is accordingly an object of the invention to provide a switching device and a corresponding method for activating a load which overcomes the above-mentioned disadvantages of the heretofore-known methods of this general type, which achieves a safe state of a system using as few redundancy measures as possible.

According to the invention, the object is achieved by a switching device containing a first register for the acquisition of control data from an external control device, a second register for the acquisition of the same control data from the external control device, a third register for outputting data to the load to be controlled, and a transmission device for transmitting data from the second register to the third register. A first comparison logic is provided for comparing the content of the second register with that of the third register and for sending an interrupt or control signal to the external control device, if the two contents are not identical. A second comparison logic is provided for comparing the content of the first register with that of the second register and for enabling the transmission device, if the contents of the two registers are identical, and otherwise for blocking the transmission device.

Provision is also made in accordance with the invention for a control system for activating a load using a switching device described above and a control device which has a first output interface for outputting the control data to the first register, a second output interface for outputting the same control data to the second register, and a control signal processing unit, so that a data output is initiated in the first and second output interface respectively, if the control signal processing unit receives a corresponding interrupt or control signal from the first comparison logic.

Furthermore, in order to achieve the aforementioned object, a method is provided for activating a load by comparing a first data record of a second register with a second data record of a third register, activating the load with the second data record of the third register, if the first and second data record are identical, otherwise carrying out of the following steps: overwriting the first data record with a third data record in a second register, transmitting a fourth data record with the same data of the third data record to a first register, comparing the data records in the first register and in the second register, copying the third data record from the second register into the third register, if the third and fourth data record are identical, and activating the load with the third data record of the third register, if the copied third data record in the third register is identical to the third data record in the second register.

The aforementioned switching device preferably has a SPI interface, the receive register of which is the first register. A serial standard interface can thus be used for the switching device.

The switching device according to the invention can also be configured as an ASIC. A form of the switching device that lends itself to series production can thus be provided.

According to a particularly preferred embodiment, the switching device has a safety unit that only enables the transmission device when it has received a suitable key from the external control unit. This can thus ensure that the external control device and the communication to the switching device function in a fault-free manner before the load with the new data is activated.

According to a further advantageous embodiment, the first output interface is of a serial configuration and the second output interface of a parallel configuration. There is a high degree of certainty that the load should actually be reactivated with the transmitted data only when the data is transmitted similarly via these two different interfaces

Other features which are considered as characteristic for the invention are set forth in the appended claims.

Although the invention is illustrated and described herein as embodied in a switching device and a corresponding method for activating a load, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE DRAWING

The single FIGURE of the drawing is a block diagram of a control system according to the invention.

### DETAILED DESCRIPTION OF THE INVENTION

Referring now to the single FIGURE of drawing in detail, there is shown in the FIGURE, a central unit 1 e.g. in a motor vehicle is used to activate a load 2. By way of example, the load 2 can be a motor, a valve or such. A driver 3 is connected in the known manner upstream of the load, the driver providing the corresponding power to activate the load 2. It is likewise connected in the known manner, with the aid of switches 4, 5, between “terminal 31” (earth) and “terminal 30” (battery voltage) in order to offer double security.

Load 2 is not activated directly via the central unit 1, which generally has a microcontroller, but instead via a component connected therebetween, here the ASIC 6. This is generally made up of three register blocks 7, 8 and 9. It also has a first comparison logic 10 for comparing the register 7 with the register 8 and a second comparison logic 11 for comparing the register 8 with the register 9.

The second comparison logic 11 always generates an interrupt IRQ or NMI or a corresponding control signal when the states of the registers 8 and 9, i.e. their register contents S1 to Sn and R1 to Rn, are different. The register 8 represents the current states at a point in time t=t1+1. The controlling central unit 1, which has a GPIO interface 12, supplies the data for the register 8 in parallel.

The register 9 with the register contents R1 to Rn represents the states at the point in time t=t1 and thus the current configuration that resulted in the corresponding activation of the load 2. If the state of the register 8 does not correspond to the state of the register 9, then this imbalance must have inevitably been caused by the controlling central unit 1. The generated interrupt request (IRQ) of the ASIC 6 starts the now described communication routine of the ASIC 6 with the central unit 1.

In the event of a dissimilarity in the register contents S1 to Sn and R1 to Rn of the registers 8 and 9, the second logic 11 sends, as mentioned, an interrupt request (IRQ) together with a key (keyword) to the central unit 1. An interrupt handler 17, which is integrated in the central unit, picks up the interrupt request (IRQ) and ensures that the parallel interface GPIO 12 (General Purpose Input/Output) transmits data in parallel to the register 8 of the ASIC 6. Initiated by the interrupt request (IRQ), a standard interface (SPI) 13 (Serial Peripheral Interface) simultaneously sends the same data D/O in series to the corresponding receiver interface 14 of the ASIC 6. With this data Di or DO, control bits CS (here e.g. the key), which was transmitted with the interrupt request (IRQ) to the central unit 1, are also transmitted back to the ASIC 6.

The SPI interface 14 of the ASIC 6 has, as already mentioned above, the first register 7 with the register contents Q1 to Qn, in which register the data received serially is now stored. The first comparison logic 10 now compares the contents of the register 7 and 8 and checks the received key. If the contents of the two registers 7 and 8 are identical and the key is correct, then a driver circuit 19 is used to transmit the register contents S1 to Sn of the register 8 into the register 9. The comparison thus enables a check to be made as to whether the serial transmission (SPI) and the parallel transmission (GPIO) have taken place correctly. That is, the redundant transmission provides information as to whether the central unit 1 and the ASIC 6 are functioning correctly. In this way, it is possible for instance to ensure that the program sequences of the central unit 1 are executed as expected.

If the key is not correct and/or the information in the third register 9 does not match that in the second register 8, then the state of the source register 8 remains unchanged. Therefore the register 8 does not become transparent for the register 9 and the original activation state of the load 2 remains unchanged. The last held state is maintained thus in the event of an error. An error event can occur for example as the result of a voltage reset, a software error, failed I/O Ports in the central unit 1, electromagnetic interference etc.

By use of the communication of the central unit 1 with the ASIC 6, the central unit 1 is, according to the invention, again actively prompted to confirm the conditions that led to a change in state. A further advantage of the system according to the invention lies in the use of control bits separate from data bits (information). This separation in conjunction with the redundant transmission prevents a single error (failed ports in the central unit 1) from already leading to an undefined, insecure system state. The key thus acts on the output register 9 like an access authorization.

The ASIC 6 can be supplied with voltage (+12V) via the protected “terminal 30”. To this end, a voltage transformer 15 is integrated into the ASIC 6 in the example shown in the FIGURE. The output voltage of the voltage transformer is Vcc_{—}1. In addition the voltage supply can also be provided via a voltage Vcc_{—}2. A corresponding logic 16 ensures that the ASIC 6 or the SPI interface 14 is supplied with the voltage Vcc_{—}1 or Vcc_{—}2.

Therefore, the voltage supply with its own voltage regulator 15 can be easily provided in the ASIC 6 as the power consumption, which is essentially determined by the registers 7, 8, 9, is very low (generally <50 μA). This low power consumption allows the power loss, that is produced in the transformation from +12V to +Vcc_{—}1(+3V/+5V), to be kept low.

A signal is transmitted from the load 2 to the central unit 1 for diagnosis purposes. The central unit 1 has an AD converter 18 for this purpose.

The ASIC according to the invention represents a cost-effective alternative to typical safety concepts, which are based exclusively on redundancy, which is realized on at least two microcontrollers divided by program sequences for example. By use of the redundant information processing (parallel processing by GPIO and serial processing by SPI) single errors can be reliably detected.

1. A switching device, comprising:
a first register for acquiring control data from an external control device;
a second register for acquiring the same control data from the external control device;
a third register for outputting data to a load to be controlled;
a transmission device for transmitting data from said second register to said third register;
a first comparison logic for comparing a content of said second register with that of said third register and for sending one of an interrupt signal and a control signal to the external control device, if the two contents are not identical; and
a second comparison logic for comparing a content of said first register with that of said second register and for enabling said transmission device, if said contents of said first and second registers are identical, and otherwise for blocking said transmission device.

2. The switching device according to claim 1, further comprising a serial peripheral interface (SPI), a receiving register of said SPI is said first register.

3. The switching device according to claim 1, wherein the switching device is an ASIC.

4. The switching device according to claim 1, further comprising a safety unit, which only then enables said transmission device when said safety unit has received a suitable key from the external control device.

5. A control system for activating a load, the control system comprising:
a control device;
a switching device containing:
a first register for acquiring control data from said control device;
a second register for acquiring the same control data from said control device;
a third register for outputting data to the load to be controlled;
a transmission device for transmitting data from said second register to said third register;
a first comparison logic for comparing a content of said second register with that of said third register and for sending one of an interrupt signal and a control signal to the external control device, if the two contents are not identical; and
a second comparison logic for comparing a content of said first register with that of said second register and for enabling said transmission device, if said contents of said first and second registers are identical, and otherwise for blocking said transmission device;
said control device having a first output interface for outputting the control data to said first register, a second output interface for outputting the same control data to said second register, and a control signal processing unit, so that a data output is initiated in each instance in said first and second output interfaces, when said control signal processing unit receives one of the interrupt signal and the control signal from said first comparison logic.

6. The control system according to claim 5, wherein said first output interface is a serial interface and said second output interface is a parallel interface.

7. A method for activating a load, which comprises the steps of:
comparing a first data record of a second register with a second data record of a third register;
activating the load with the second data record of the third register, if the first and second data records are identical, otherwise carrying out the following steps:
overwriting the first data record with a third data record in the second register;
transmitting a fourth data record with the same data of the third data record to a first register;
comparing the data records in the first register and the second register;
copying the third data record from the second register into the third register, if the third and the fourth data record are identical; and
activating the load with the third data record of the third register, if the copied third data record in the third register is identical to the third data record in the second register.

8. The method according to claim 7, wherein data is transmitted in parallel into the second register, while data is transmitted serially into the first register.

9. The method according to claim 7, wherein the third data record originates from a control device to which, in order to initiate an overwriting of the first data record with the third data record, one of an interrupt signal and a control signal is transmitted together with a key, which is transmitted together with the fourth data record to a communication unit, which is connected to the first register, wherein the third data record is only copied from the second register into the third register, if the key has a predetermined form or a predetermined value.
